(19) United States
(12) Patent Application Publication
(10) Pub. No.: US 2011/0231532 A1
(43) Pub. Date: Sep. 22, 2011

(54) Network management apparatus, network management method and network management program

(75) Inventors: Masaki Nishimura, Fukuoka (JP); Manabu Iwasaki, Fukuoka (JP)

(73) Assignee: Fujitsu Limited, Kawasaki (JP)

(21) Appl. No.: 12/929,972

(22) Filed: Feb. 28, 2011

(30) Foreign Application Priority Data
Mar. 19, 2010 (JP) 2010-064528

(51) Int. Cl. G06F 15/177

(52) U.S. Cl. 709/221

(57) ABSTRACT

A network management apparatus includes a processor, and a storage. The storage that stores an operation type indicating a rollback operation method by associating with attributes held by a command defining network settings. The processor executes extracting a difference between a command forming current setting information and a command forming previous setting information when the setting information set by the command is brought back to the previous setting information and acquiring the operation type corresponding to extracted command attributes from the storage unit, to generate a rollback command defining the rollback operation in accordance with the acquired operation type.

### CROSS-REFERENCE TO RELATED APPLICATION

This application is based upon and claims the benefit of priority of the prior Japanese Patent Application No. 2010-064528, filed on Mar. 19, 2010, the entire contents of which are incorporated herein by reference.

### FIELD

The embodiments discussed herein are directed to a network management apparatus, a network management method, and a network management program.

### BACKGROUND

When a computer network system is built, a network management apparatus conventionally sets environment information to perform network monitoring and control of network devices in the network system. To set the environment information with ease, the network management apparatus may use “provisioning” that automatically converts parameter information regarding the environment information input by the network administrator into a command and automatically executes the converted command.

When environment settings are made by using the provisioning, the provisioning may fail depending on the operating condition of a network device or environment settings in a network device. In such a case, a technology to bring environment settings of a network device to the state before the provisioning fails by executing a command (reverse command) that cancels the executed command has been developed. Bringing back environment settings to the previous state is called a rollback. If, for example, a “Set” command is executed in the provisioning, a “Delete” command, which is the reverse command of this command, is executed and if the “Delete” command is executed, the “Set” command, which is the reverse command of this command, is executed.

Patent Literature 1: Japanese Laid-open Patent Publication No. 03-181260

Patent Literature 2: Japanese Laid-open Patent Publication No. 09-168009

However, if the provisioning fails, there is a problem that even if the reverse command of the executed command is executed, the state before the failed provisioning may not be restored. That is, if the reverse command of the command executed in the provisioning does not simply perform the reverse operation of the command executed in the provisioning, an extra influence will be exerted so that the proper state before the failed provisioning is not restored.

An example in which the reverse command of some command does not simply perform the reverse operation of some command will be described with reference to FIGS. 12 and 13A to 13C. FIG. 12 is a diagram exemplifying a provisioning failure in an Multi Protocol Label Switching-Virtual Private Network (MPLS-VPN) and FIGS. 13A to 13C are diagrams illustrating a configuration after each step of provisioning. As illustrated in FIG. 12, a network management apparatus makes MPLS-VPN settings between a Customer Edge (CE) router illustrating a customer-side edge and a Provider Edge (PE) router illustrating a provider-side edge. Here, the CE router is assumed to be a CE router a and the PE router to be a PE router a.

More specifically, the network management apparatus first adds a service of a static protocol, which is a static routing method of an Internet Protocol Version 4 (IPv4) network, to MPLS-VPN settings between the CE router a and the PE router a (step S1). A command corresponding to the service of the static protocol for the IPv4 network between the CE router a and the PE router a is thereby added to the configuration.

Next, the network management apparatus adds a service of the static protocol for an Internet Protocol Version 6 (IPv6) network to MPLS-VPN settings between the CE router a and the PE router a (step S2). As illustrated in FIG. 13A, a command (for example, C1) corresponding to the service of the static protocol for the IPv6 network between the CE router a and the PE router a is thereby added to the configuration.

Next, the administrator inputs a command to the MPLS-VPN settings between the CE router a and the PE router a by a manual operation to change the service for the IPv6 network (step S3). As illustrated in FIG. 13B, a bi-directional forwarding detection (bfd) command C2 for the IPv6 network between the CE router a and the PE router a is added to the configuration. Here, the bfd command C2 is added to the same line as that to which the command C1 is added in step S2. The bfd command C2 is a command that may not be forecast by the network management apparatus because the command is set from outside the network management apparatus.

In this state, the network management apparatus changes the service involved in the protocol of the IPv6 network in the MPLS-VPN settings between the CE router a and the PE router a (step S4). In this case, an event in which the network setting fails and a rollback is performed occurs and thus, the network management apparatus attempts to cancel the service managed by the apparatus and involved in the protocol of the IPv6 network, which leads to the input of the reverse command of the command corresponding to the service. Then, the network management apparatus may not take processing for the bfd command C2 input by the administrator in step S3 into consideration. More specifically, as illustrated in FIG. 13C, the configuration is changed so that the communication protocol of the IPv6 network between the CE router a and the PE router a is changed from static to BGP. In this case, the network management apparatus inputs a reverse command C3 of the command C1 managed by the apparatus to the MPLS-VPN settings. Then, the network management apparatus may not reflect the BFD command C2 that may not be forecast in the configuration. That is, even if the reverse command C3 of the command C1 is executed, the reverse command C3 does not simply perform the reverse operation of the command C1 and thus, an extra influence will be exerted so that the proper state immediately before the failed provisioning is not restored.

The above subject is a subject that, in addition to a case of a failure of provisioning, similarly arises when the configuration after settings by provisioning is brought back to that before settings thereby.

### SUMMARY

According to an aspect of an embodiment of the invention, a network management apparatus includes a processor and a storage that stores an operation type indicating a rollback operation method by associating with attributes held by a command defining network settings. Wherein the processor executes extracting a difference between a command forming current setting information and a command forming previous setting information when the setting information set by the command is brought back to the previous setting information; and acquiring the operation type corresponding to extracted command attributes from the storage unit, to generate a rollback command defining the rollback operation in accordance with the acquired operation type.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a function block diagram illustrating a configuration of a network management apparatus according to a first embodiment;

FIG. 2 is a function block diagram illustrating the configuration of a network management apparatus according to a second embodiment;

FIG. 3 is a diagram exemplifying a template of a static protocol;

FIG. 4 is a diagram exemplifying a data structure of a command template table;

FIG. 5 is a diagram exemplifying the data structure of a management data table;

FIG. 6 is a diagram exemplifying the data structure of a backup management data table;

FIG. 7 is a diagram exemplifying a rollback operation classification table;

FIG. 8 is a diagram exemplifying the data structure of a rollback operation determination table;

FIG. 9A is a flow chart illustrating a processing procedure of the network management apparatus according to the second embodiment;

FIG. 9B is a flow chart illustrating the procedure for rollback determination processing;

FIG. 9C is a flow chart illustrating the procedure for rollback determination result setting command generation processing;

FIG. 10 is a diagram illustrating a concrete example of rollback setting command generation;

FIG. 11 is a diagram illustrating a concrete example of the rollback setting command generation;

FIG. 12 is a diagram exemplifying a conventional provisioning failure;

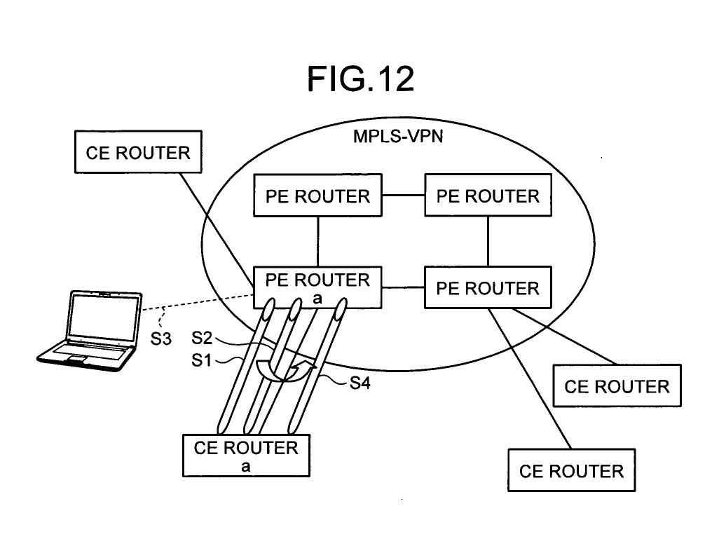

FIG. 13A is a diagram (configuration when MPLS-VPN settings are made for an IPv6 network) illustrating a provisioning result;

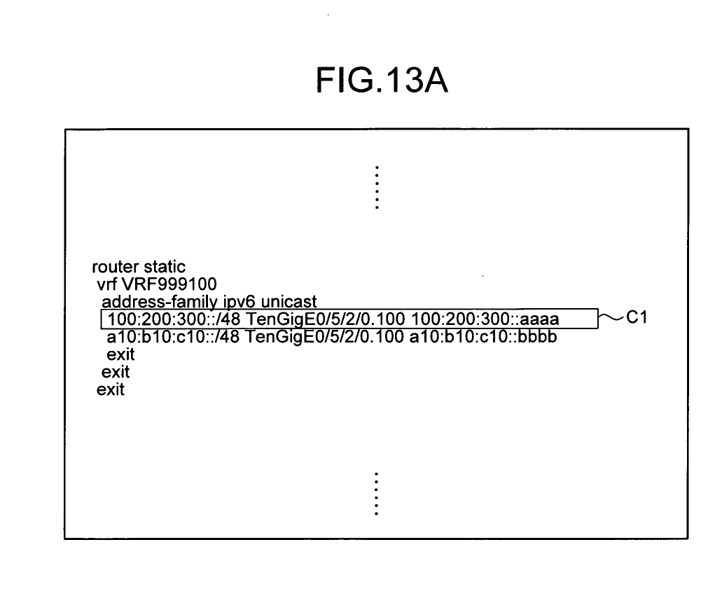

FIG. 13B is a diagram (configuration when a command is input for the IPv6 network) illustrating a provisioning result;

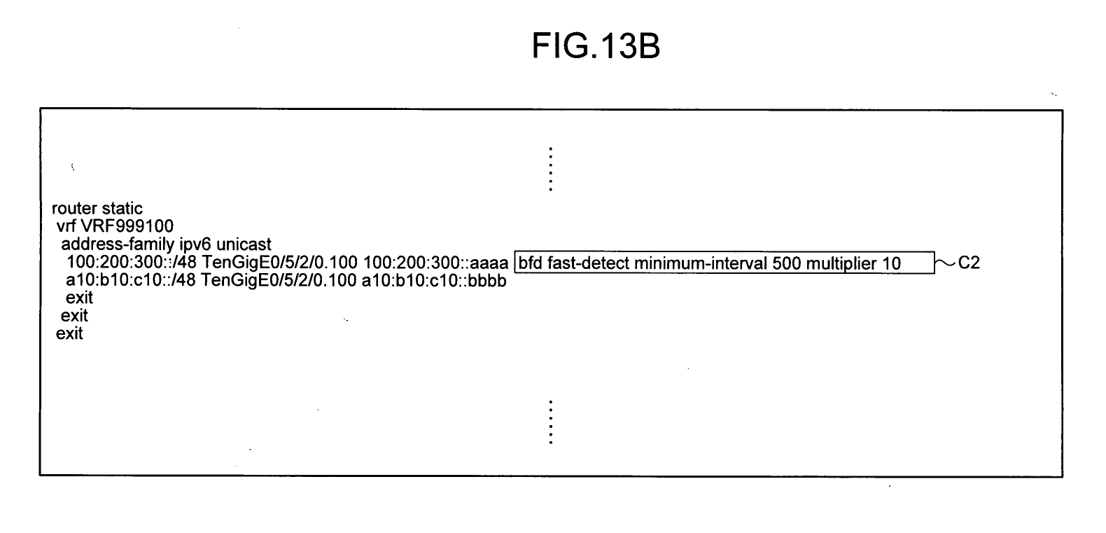

FIG. 13C is a diagram (configuration when the communication of the IPv6 network is changed from Static to BGP) illustrating a provisioning result; and

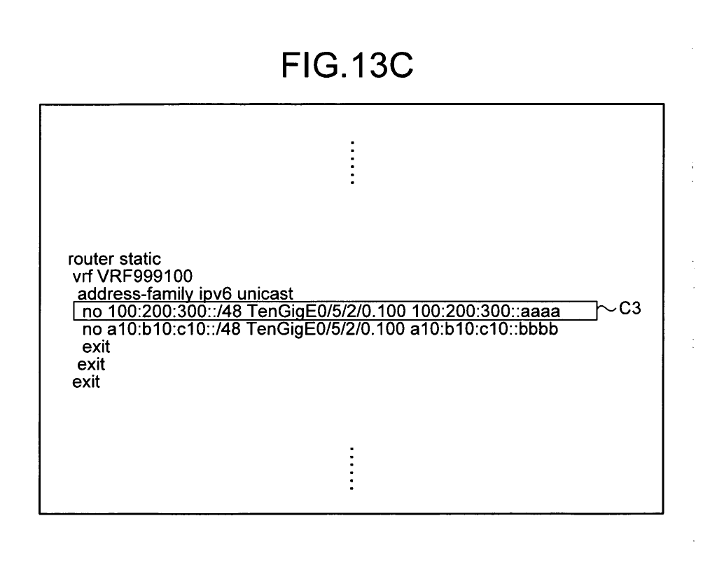

FIG. 14 is a diagram illustrating a computer executing a network management program.

### DESCRIPTION OF EMBODIMENTS

Preferred embodiments of the present invention will be explained with reference to accompanying drawings. Embodiments below illustrate a case when the present invention is applied to a network management apparatus that sets setting information for monitoring/controlling an Internet Protocol (IP) network to a network device such as a router connected to a network by using provisioning. However, the present invention is not limited by such embodiments and the present invention is applicable to a network device connected to a Multi Protocol Label Switching-Virtual Private Network (MPLS-VPN) network and also to a network device connected to other networks.

### [a] First Embodiment

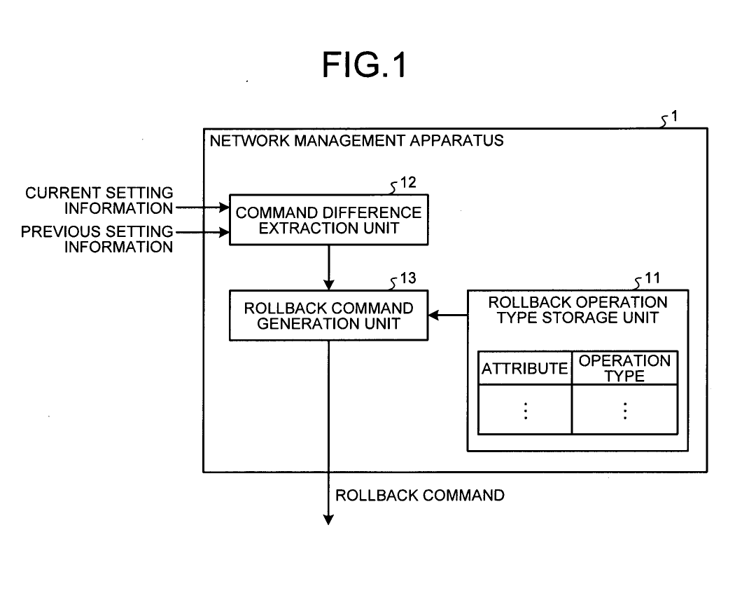

FIG. 1 is a function block diagram illustrating the configuration of a network management apparatus according to the first embodiment. As illustrated in FIG. 1, a network management apparatus 1 includes a rollback operation type storage unit 11, a command difference extraction unit 12, and a rollback command generation unit 13.

The rollback operation type storage unit 11 stores an operation type indicating a rollback operation method by associating with attributes held by a command defining network settings. The command difference extraction unit 12 extracts a difference between a command forming current setting information and a command forming previous setting information when the setting information set by the command defining network settings is brought back to the previous setting information.

The rollback command generation unit 13 acquires the operation type corresponding to command attributes extracted by the command difference extraction unit 12 from the rollback operation type storage unit 11 to generate a rollback command defining the rollback operation in accordance with the acquired operation type.

Thus, when the network management apparatus 1 generates a rollback command that cancels the command forming the current setting information, the network management apparatus 1 generates a rollback command in accordance with the operation type associated with attributes held by the command. Thus, in contrast to a case when a rollback command that simply cancels a command, the network management apparatus 1 can generate an appropriate rollback command.

Moreover, based on the rollback operation type storage unit 11 defining the operation method of rollback associated with attributes held by a command, the network management apparatus 1 generates a rollback command corresponding to the command. Thus, if, for example, provisioning fails and previous setting information may be restored, the network administrator may not analyze the cause of failure to determine the rollback command. That is, the network management apparatus 1 automatically generates a rollback command to restore proper setting information before the provisioning.

### [b] Second Embodiment

Overview of network management apparatus according to second embodiment

A network management apparatus according to the second embodiment sets the configuration for monitoring/controlling a network by using provisioning for network devices connected to an MPLS-VPN network. At this point, the network management apparatus may bring the configuration set by the provisioning back to the configuration before the provisioning. In such a case, it is preferable for the network management apparatus to roll back to the appropriate configuration before the provisioning.

Thus, the network management apparatus stores the operation type indicating the operation method of rollback by associating with attributes held by a command defining network settings in advance. Then, when the configuration set by a command may be brought back to the configuration before provisioning, the network management apparatus extracts a difference between a command forming the configuration after provisioning and a command forming the configuration before provisioning. Then, the network management apparatus acquires the operation type corresponding to command attributes extracted as the difference from the storage apparatus and generates a rollback command corresponding to the acquired operation type and defining the rollback operation. A case when the configuration before provisioning is restored is a case when provisioning failed or the protocol, IP address or the like before provisioning is restored, but is not limited to such cases.

Configuration of Network Management Apparatus According to Second Embodiment

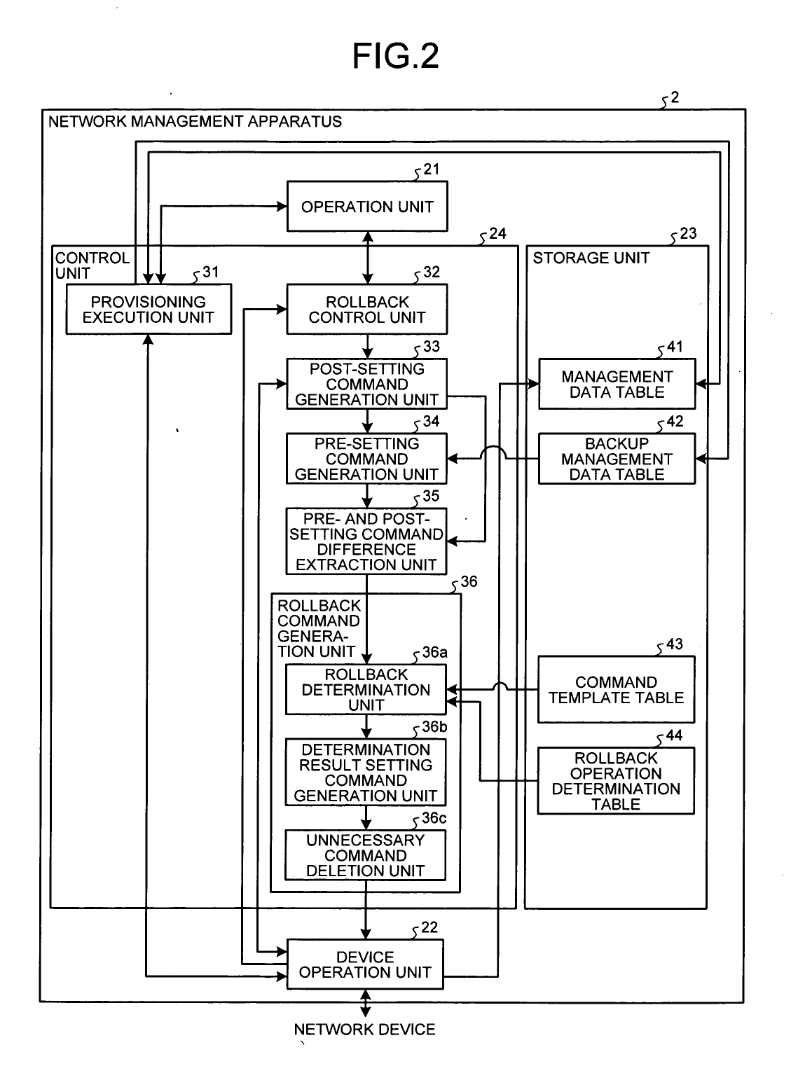

FIG. 2 illustrates the configuration of a network management apparatus according to the second embodiment. FIG. 2 is a function block diagram illustrating the configuration of a network management apparatus according to the second embodiment. As illustrated in FIG. 2, a network management apparatus 2 according to the second embodiment includes an operation unit 21, a device operation unit 22, a storage unit 23, and a control unit 24. For example, the control unit 24 is a processor. The device operation unit 22 is connected to a network device for which the configuration is set by provisioning. The network device is a CE router, PE router or the like.

The operation unit 21 is an apparatus to be operated when provisioning or rollback is performed and includes, for example, a keyboard, a mouse, and a monitor. The device operation unit 22 executes a command for a network device according to instructions received from the control unit 24. The device operation unit 22 also notifies the control unit 24 of results received from network devices.

The storage unit 23 includes a management data table 41, a backup management data table 42, a command template table 43, and a rollback operation determination table 44. The storage unit 23 is, for example, a semiconductor memory device such as a Random Access Memory (RAM) and flash memory or a storage apparatus such as a hard disk and optical disk.

The control unit 24 includes a provisioning execution unit 31, a rollback control unit 32, a post-setting command generation unit 33, a pre-setting command generation unit 34, a pre- and post-setting command difference extraction unit 35, and a rollback command generation unit 36. Further, the rollback command generation unit 36 includes a rollback determination unit 36a, a determination result setting command generation unit 36b, and an unnecessary command deletion unit 36c.

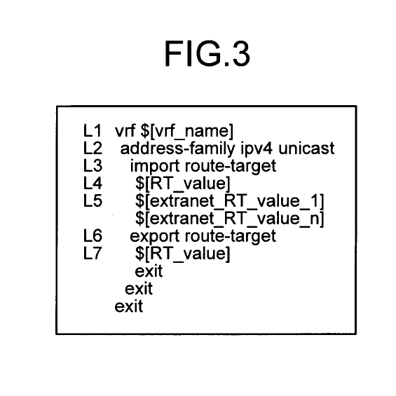

The command template table 43 stores templates of commands that may be set to the configuration and also attributes held by the commands. The data structure of the command template table 43 will be described while illustrating an example of the template. FIG. 3 is a diagram exemplifying the template. As illustrated in FIG. 3, an example of commands that may be set to the configuration of a static protocol is illustrated.

In line L1, a virtual/VPN routing and forwarding (vrf) command is illustrated. The vrf command has a parameter to specify the VPN name to allocate a network partition to a VPN. In line L2, a command declaring an address family of IPv4 is illustrated. In line L3, a command to create an import route-target in the allocated VRF is illustrated. In line L4, a command to specify an IP address and net mask of the import route-target is illustrated. In line L5, a command to specify a physical interface name is illustrated. In line L6, a command to create an export route-target in the in the allocated VRF is illustrated. In line L7, a command to specify an IP address of the export route-target is illustrated.

Next, attributes of these commands will be described. Attributes could impose constraints when a rollback command is generated. It is assumed here that an “overwrite attribute”, “multi-setting attribute”, and “deletion influence range attribute” are considered as attributes. The “overwrite attribute” is an attribute indicating whether a command can be overwritten when the command is updated. The “multi-setting attribute” is an attribute indicating whether a plurality of commands may consecutively be set. The “deletion influence range attribute” is an attribute indicating whether a single or a plurality of command ranges is influenced when a command is deleted.

The above attributes will be described more specifically. The vrf command illustrated in line L1 sets the overwrite attribute to “Not permitted”, the multi-setting attribute to “Multi-setting present”, and the deletion influence range attribute to “a plurality of command ranges because line L1 to line L7 are influenced”. The IPv4 declaration command illustrated in line L2 sets the overwrite attribute to “Not permitted”, the multi-setting attribute to “No multi-setting”, and the deletion influence range attribute to “a plurality of command ranges because line L2 to line L7 are influenced”. The import route-target creation command illustrated in line L3 sets the overwrite attribute to “Not permitted”, the multi-setting attribute to “No multi-setting”, and the deletion influence range attribute to “a plurality of command ranges because line L3 to line L5 are influenced”. The IP address specifying command of the import route-target illustrated in line L4 sets the overwrite attribute to “Permitted”, the multi-setting attribute to “No multi-setting”, and the deletion influence range attribute to “single command range because only line L4 is influenced”. The physical interface name specifying command illustrated in line L5 sets the overwrite attribute to “Not permitted”, the multi-setting attribute to “Multi-setting present”, and the deletion influence range attribute to “single command range because only line L5 is influenced”. The export route-target specifying command illustrated in line L6 sets the overwrite attribute to “Not permitted”, the multi-setting attribute to “No multi-setting”, and the deletion influence range attribute to “a plurality of command ranges because line L6 and line L7 are influenced”. The IP address specifying command of the export route-target illustrated in line L7 sets the overwrite attribute to “Permitted”, the multi-setting attribute to “No multi-setting”, and the deletion influence range attribute to “single command range because only line L7 is influenced”.

Each command from line L3 to line L7 may have attributes set for each command or set together in one line for these commands. When these commands have attributes set together in one line, the overwrite attribute is set to “Not permitted”, the multi-setting attribute to “Yes”, and the deletion influence range attribute to “single command range because only the local line is influenced”. In the description that follows, it is assumed that the latter case in which attributes are set together in one line is adopted.

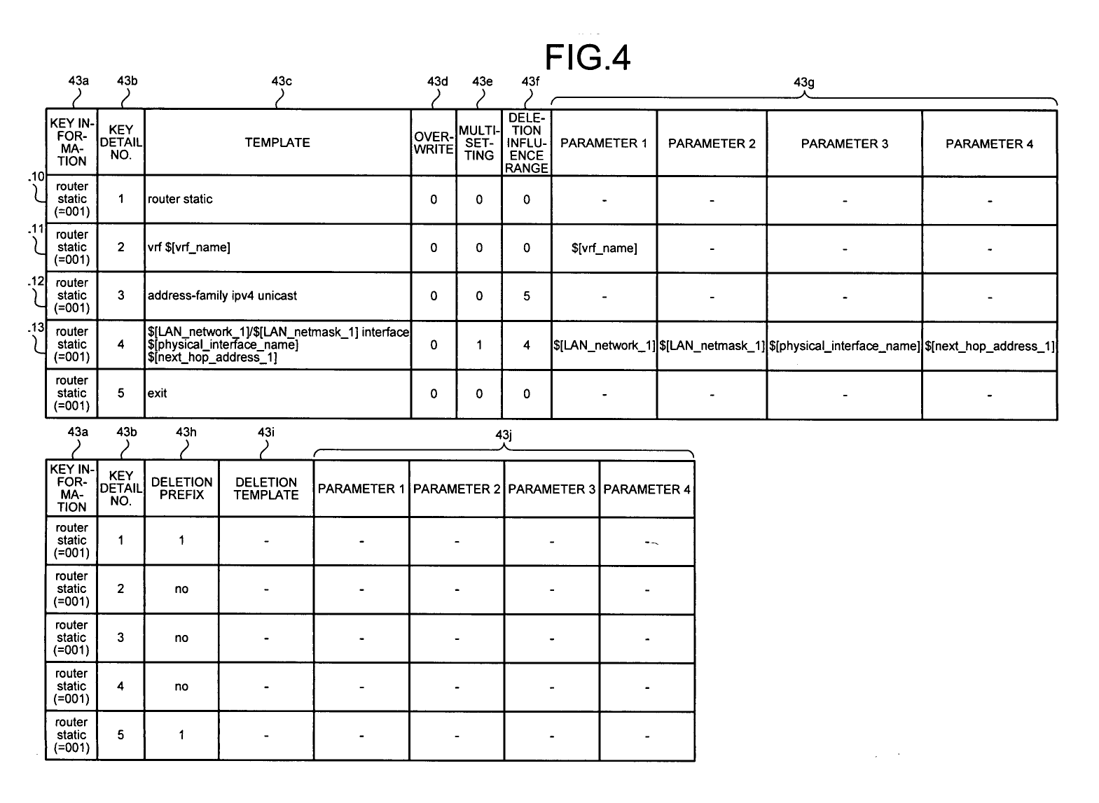

The command template table 43 for this template of a static protocol will be following. FIG. 4 is a diagram exemplifying the data structure of the command template table 43. As illustrated in FIG. 4, the command template table 43 stores a template 43c of a command, an overwrite 43d, a multi-setting 43e, and a deletion influence range 43f attributes of the command, and parameters 43g of the template by associating with each piece of key information 43a and each key detail No. 43b. Further, the command template table 43 stores a deletion prefix 43h, a deletion template 43i, and parameters 43j of the deletion template 43i by associating with each of the templates 43c.

More specifically, the key information 43a indicates an identification number defined for each protocol used by network devices. For example, the identification number of the static protocol may be set as “001” and that of the BGP protocol (not illustrated) as “002”. The key detail No. 43b is an identification number for each of the templates 43c described later and attached in ascending order.

The template 43c indicates a template of the command and is illustrated in a form containing parameters. Here, the template 43c illustrated in line L10 represents a template of the command whose routing protocol indicates to be static. The template 43c illustrated in line L11 represents a template of the vrf command corresponding to line L1 illustrated in FIG. 3 and is illustrated in a form containing a parameter to specify the VRF name. The template 43c illustrated in line L12 represents a template of the IPv4 declaration command corresponding to line L2 illustrated in FIG. 3. The template 43c illustrated in line L13 represents a template of various address setting commands from line L3 to line L7 illustrated in FIG. 3. Various address setting commands are illustrated in a form containing parameters to specify, for example, the IP address of the import route-target, net mask thereof, physical interface name, and IP address of the export route-target. The template 43c may be, in consideration of attributes of successive commands, a template of one command or a template including a plurality of commands. The template of various address setting commands illustrated in line L3 described above is a template including a plurality of commands.

The overwrite 43d indicates the overwrite attribute for each command indicated by the template 43c. For example, “0” is set for “Not permitted”, “1” for “Permitted”, and “2” for “Not applicable”.

The multi-setting 43e indicates the multi-setting attribute for each command indicated by the template 43c. For example, “0” is set for “No multi-setting”, “1” for “Multi-setting present”, and “2” for “Not applicable”.

The deletion influence range 43f indicates the deletion influence range attribute for each command indicated by the template 43c and the value of the key detail No. 43b influenced by command deletion. If the value of the key detail No. 43b influenced as the deletion influence range 43f after a command illustrated in line L13 being deleted is “4”, the value of the deletion influence range 43f and the value of the key detail No. 43b match, which indicates the deletion influence range is single.

The parameters 43g of a template indicate the format of parameters contained in the template 43c. The deletion prefix 43h indicates command generation rules when a command indicated by the template 43c is canceled. In the case of “no”, for example, the deletion prefix 43h indicates the prefix of a command when the command indicated by the template 43c is canceled. “0” indicates that “the deletion command is not needed” for the command indicated by the template 43c. That is, in this case, an upper-level deletion command is used for deletion in a superimposed manner. “1” indicates “inputting the command unconditionally”. “3” indicates “a deletion command other than the prefix”.

The deletion template 43i indicates a template of a deletion command pattern when the deletion prefix 43h is “3”, that is, “a deletion command other than the prefix” and is illustrated in a form containing parameters. The parameters 43j of a deletion template indicates the format of parameters contained in the deletion template 43i.

For example, a case when an attribute of a command that can be set to the configuration is added or changed due to upgrades of firmware of network devices can be considered. Even in such a case, attributes of the command can be added to the command template table 43 or changed.

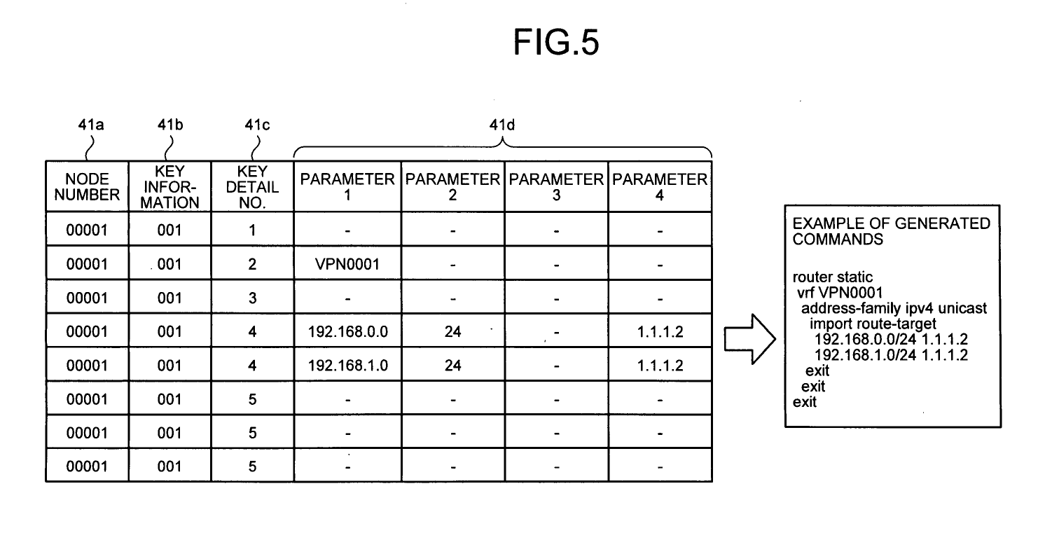

Returning to FIG. 2, the management data table 41 stores content of the latest configuration set to a network device. That is, the management data table 41 stores content of the configuration set to the network device immediately after provisioning. The data structure of the management data table 41 will be described with reference to FIG. 5. As illustrated in FIG. 5, the management data table 41 stores a node number 41a, key information 41b, and parameters 41d by associating with each key detail No. 41c.

The node number 41a indicates the number of a node to which a network device connected to an MPLS-VPN network belongs. The key information 41b and the key detail No. 41c are similar to the key information 43a and the key detail No. 43b of the command template table 43 and thus, a description thereof is omitted. The parameters 41d are content of actual parameters of a command set to the configuration. The parameters 41d when the key detail No. 41c is, for example, “4” mean the parameters 43g of various address setting commands contained in the template 43c in line L13 of the command template table 43. Thus, parameters 1 to 4 of the parameters 41d store content of the actual parameters 1 to 4 corresponding to the parameters 43g.

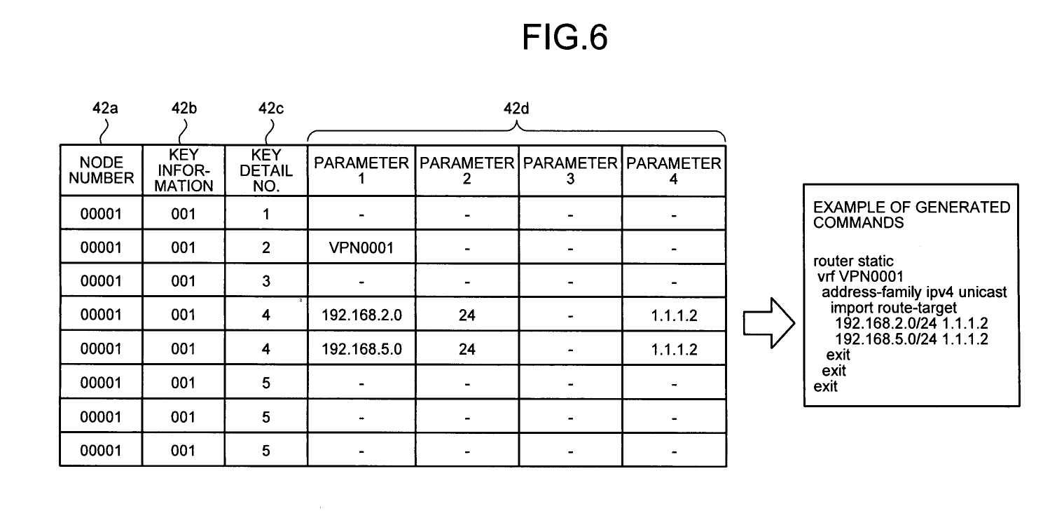

Returning to FIG. 2, the backup management data table 42 stores content of the configuration of network devices immediately before provisioning. That is, the backup management data table 42 is the configuration of network devices immediately before provisioning managed by the network management apparatus 2 and stores content of the configuration one generation before. The data structure of the backup management data table 42 is as illustrated in FIG. 6 and similar to that of the management data table 41 and thus, a description thereof is omitted.

Returning to FIG. 2, the provisioning execution unit 31 performs provisioning based on content of the provisioning specified by the operation unit 21. More specifically, the provisioning execution unit 31 reads content of the latest configuration and managed by the management data table 41 and saves the read content in the backup management data table 42. The content read from the management data table 41 becomes the configuration one generation before after provisioning and thus, the content is backed up in advance. The provisioning execution unit 31 coverts the read content into commands to generate a command sequence forming the configuration to perform provisioning. Then, the provisioning execution unit 31 makes a request of the device operation unit 22 to perform provisioning including a generated command sequence. After receiving a result of performing provisioning from the device operation unit 22, the provisioning execution unit 31 reflects the result in the management data table 41 and also notifies the operation unit 21 of the result.

The rollback control unit 32 makes a request of the post-setting command generation unit 33 to perform rollback based on rollback content specified by the operation unit 21. The rollback control unit 32 also acquires a rollback execution result by a rollback operation described later from the device operation unit 22 and then notifies the operation unit 21 of the execution result. Since the configuration of network devices goes back one generation by the rollback, the rollback control unit 32 overwrites the management data table 41 with content of the configuration stored in the backup management data table 42. Then, the rollback control unit 32 discards content of the configuration stored in the backup management data table 42 because there is no configuration still one generation before.

The post-setting command generation unit 33 converts the latest configuration immediately after provisioning set to the network device to be rolled back into commands to generate a post-setting command sequence. More specifically, after receiving an instruction to make a request to perform rollback from the rollback control unit 32, the post-setting command generation unit 33 instructs the device operation unit 22 to make a request of the network device to be rolled back contained in the instruction of execution request to extract the current configuration. After acquiring an extraction result of the current configuration of the network device from the device operation unit 22, the post-setting command generation unit 33 generates a post-setting command sequence forming the configuration from the extraction result.

The pre-setting command generation unit 34 converts the configuration one generation before of the network device to be rolled back into commands to generate a pre-setting command sequence. More specifically, the pre-setting command generation unit 34 reads content of the configuration from the backup management data table 42 to generate a pre-setting command sequence from the content. For example, the pre-setting command generation unit 34 uses key information 42b and key detail No. 42c of the backup management data table 42 as keys to read the template 43c from the command template table 43. Then, the pre-setting command generation unit 34 replaces parameters 42d corresponding to the same key detail No. 42c of the backup management data table 42 with a parameter portion inside the read template 43c to generate one command. Then, the pre-setting command generation unit 34 performs this operation sequentially in ascending order of the key detail No. 42c to generate a pre-setting command sequence.

The pre- and post-setting command difference extraction unit 35 extracts command differences between a pre-setting command sequence and a post-setting command sequence. More specifically, the pre- and post-setting command difference extraction unit 35 breaks down a pre-setting command sequence and a post-setting command sequence into respective individual commands. The pre- and post-setting command difference extraction unit 35 also compares the same commands each from individual commands obtained by breaking down the pre-setting command sequence and those obtained by breaking down the post-setting command sequence to extract commands that have changed as differential commands. Then, the pre- and post-setting command difference extraction unit 35 temporarily stores extracted differential commands that have changed in the storage unit 23 by making a distinction about whether such commands are in the pre-setting command sequence or the post-setting command sequence.

The rollback command generation unit 36 includes the rollback determination unit 36a, the determination result setting command generation unit 36b, and the unnecessary command deletion unit 36c. The rollback determination unit 36a acquires the operation type corresponding to command attributes extracted by the pre- and post-setting command difference extraction unit 35 from the rollback operation determination table 44. The attributes here are assumed, as described above, the “overwrite attribute”, “multi-setting attribute”, and “deletion influence range attribute”.

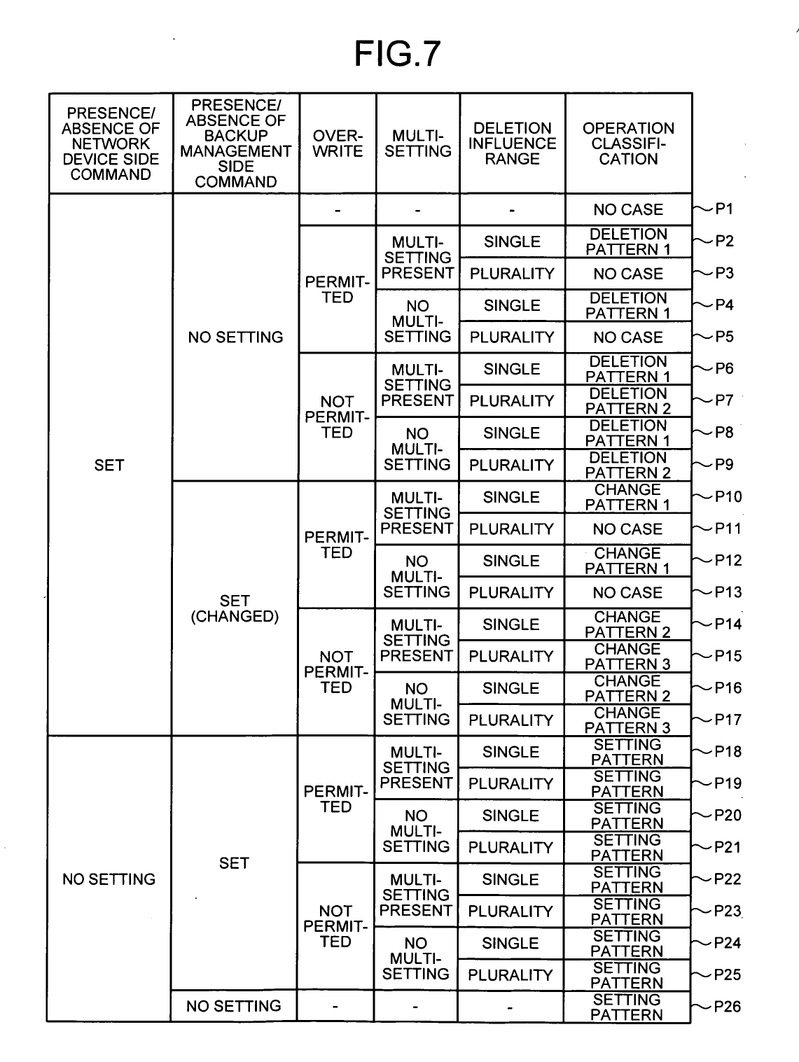

Next, the rollback operation determination table 44 will be described. The rollback operation determination table 44 stores the operation classification indicating the operation method of rollback by associating with attributes held by a command defining network settings. The rollback operation determination table 44 is created based on a rollback operation classification table described later. Thus, as a prerequisite for the rollback operation determination table 44, the rollback operation classification table will be described with reference to FIG. 7. FIG. 7 is a diagram exemplifying the rollback operation classification table. As illustrated in FIG. 7, the rollback operation classification table includes “Presence/absence of network device side command”, “Presence/absence of backup management side command”, “Overwrite attribute”, “Multi-setting attribute”, “Deletion influence range attribute”, and “Operation classification”. “Presence/absence of network device side command” indicates whether any differential command is set to the configuration on the network device side. “Presence/absence of backup management side command” indicates whether a differential command determined by “Presence/absence of network device side command” is stored in the backup management data table 42. “Overwrite attribute”, “Multi-setting attribute”, and “Deletion influence range attribute” are as described above and a description thereof is omitted. “Operation classification” indicates the operation classification indicating the operation method of rollback by associating with attributes held by a differential command. Attributes thereof are here “Overwrite attribute”, “Multi-setting attribute”, and “Deletion influence range attribute”.

The operation classification includes six patterns by being associated with attributes. The first operation classification is a deletion pattern 1. The deletion pattern 1 is an operation classification that generates a single deletion command based on a command extracted from the configuration on the network device side. More specifically, to be an operation classification of the deletion pattern 1, the command needs to have “Set” as the configuration on the network device side, “No setting” as the configuration on the backup side, and “Single” as the detection influence range attribute. In this case, other commands are not influenced by the deletion command of the command and thus, a single deletion command may be created as a rollback command. In the example in FIG. 7, P2, P4, P6, and P8 apply.

The second operation classification is a deletion pattern 2. The deletion pattern 2 is an operation classification that generates a single deletion command based on a command extracted from the configuration on the network device side and also extracts commands influenced by the deletion command so that rollback processing of the extracted commands is not performed. More specifically, to be an operation classification of the deletion pattern 2, the command needs to have “Set” as the configuration on the network device side, “No setting” as the configuration on the backup side, “Not permitted” as the overwrite attribute and “A plurality” as the detection influence range attribute. In this case, if this command is canceled, there are other commands to be canceled and thus, a single deletion command may be created for this command without creating a rollback command for the other commands. In the example in FIG. 7, P7 and P9 apply.

The third operation classification is a change pattern 1. The change pattern 1 is an operation classification that simply generates a change command based on a command extracted from the configuration on the network device side. More specifically, to be an operation classification of the change pattern 1, the command needs to have “Set” as the configuration on the network device side, “Set (Changed)” as the configuration on the backup side, “Permitted” as the overwrite attribute and “Single” as the detection influence range attribute. In this case, a changed command can be overwritten and thus, to set the command on the network device side as a command on the backup side, a change command to simply change to the command on the backup side may be generated. In the example in FIG. 7, P10 and P12 apply.

The fourth operation classification is a change pattern 2. The change pattern 2 is an operation classification that simply generates a deletion command based on a command extracted from the configuration on the network device side and simply generates a change command from a command extracted from the side of backup. More specifically, to be an operation classification of the change pattern 2, the command needs to have “Set” as the configuration on the network device side, “Set (changed)” as the configuration on the backup side, “Not permitted” as the overwrite attribute and “Single” as the detection influence range attribute. In this case, a changed command may not be overwritten and thus, a deletion command to simply delete the command on the network device side may be generated and also a setting command to simply set the command on the backup side may be generated. In the example in FIG. 7, P14 and P16 apply.

The fifth operation classification is a change pattern 3. The change pattern 3 simply generates a deletion command based on a command extracted from the configuration on the network device side. Further, the change pattern 3 extracts commands influenced by the deletion command from the backup side and generates extracted commands as change commands. More specifically, to be an operation classification of the change pattern 3, the command needs to have “Set” as the configuration on the network device side, “Set (changed)” as the configuration on the backup side, “Not permitted” as the overwrite attribute and “A plurality” as the detection influence range attribute. In this case, a changed command may not be overwritten and thus, a deletion command to simply delete the command on the network device side may be generated. There are other commands to be collectively canceled by the deletion command and a differential command among the other commands from the backup side may be simply generated as a change command from the backup side. In the example in FIG. 7, P15 and P17 apply.

The sixth operation classification is a setting pattern. The setting pattern is an operation classification that generates a command extracted from the configuration on the backup side as a setting command. More specifically, to be an operation classification of the setting pattern, the command needs to have “No setting” as the configuration on the network device side and “Set” as the configuration on the backup side. In this case, a single setting command may be generated from a command on the backup side as a rollback command regardless of command attributes. In the example in FIG. 7, patterns from P18 to P25 apply. “No case” as the operation classification is a case when there is no combination of applicable conditions.

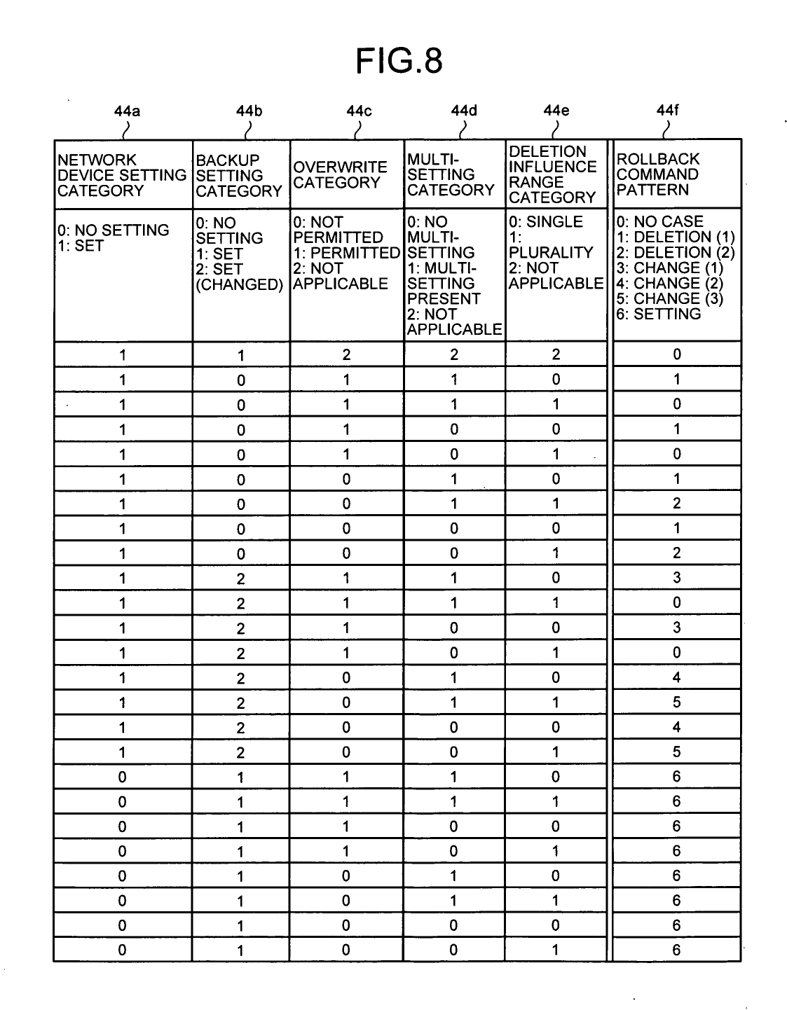

A table created by storing content of such a rollback operation classification table in the storage unit 23 is the rollback operation determination table 44. The data structure of the rollback operation determination table 44 will be described with reference to FIG. 8. FIG. 8 is a diagram exemplifying the data structure of the rollback operation determination table 44. As illustrated in FIG. 8, the rollback operation determination table 44 stores a rollback command pattern 44f by associating with each of a network device setting category 44a, a backup setting category 44b, an overwrite category 44c, a multi-setting category 44d, and a deletion influence range category 44e.

The network device setting category 44a corresponds to “Network device side command” of a rollback operation classification table. For example, “0” of the network device setting category 44a indicates that no differential command is set to the configuration on the network device side. “1” of the network device setting category 44a indicates that a differential command is set to the configuration on the network device side.

The backup setting category 44b corresponds to “Presence/absence of backup management side command” of a rollback operation classification table. For example, “0” of the backup setting category 44b indicates that no differential command is stored in the backup management data table 42. “1” of the backup setting category 44b indicates that a differential command is stored in the backup management data table 42. Further, “2” of the backup setting category 44b indicates that a differential command stored in the backup management data table 42 has changed from that on the network device side.

The overwrite category 44c corresponds to “Overwrite attribute” of a rollback operation classification table. For example, “0” of the overwrite category 44c indicates that when a differential command is updated, the differential command may not be overwritten. “1” of the overwrite category 44c indicates that when a differential command is updated, the differential command can be overwritten. Further, “2” of the overwrite category 44c indicates that, for example, the differential command is not a command to be managed and is not applicable.

The multi-setting category 44d corresponds to “Multi-setting attribute” of a-rollback operation classification table. For example, “0” of the multi-setting category 44d indicates that there is no setting of a plurality of differential commands. “1” of the multi-setting category 44d indicates that there is a setting of a plurality of differential commands. Further, “2” of the multi-setting category 44d indicates that, for example, the differential command is not a command to be managed and is not applicable.

The deletion influence range category 44e corresponds to “Deletion influence range attribute” of a rollback operation classification table. For example, “0” of the deletion influence range category 44e indicates that there is a single command range to be influenced if a differential command is deleted. “1” of the deletion influence range category 44e indicates that there is a plurality of command ranges to be influenced if a differential command is deleted. Further, “2” of the deletion influence range category 44e indicates that, for example, the differential command is not a command to be managed and is not applicable.

The rollback command pattern 44f corresponds to “Operation classification” of a rollback operation classification table. For example, “0” of the rollback command pattern 44f indicates that the operation classification indicating the operation method of rollback is no case. “1” of the rollback command pattern 44f indicates that the operation classification is the deletion pattern 1. “2” of the rollback command pattern 44f indicates that the operation classification is the deletion pattern 2. “3” of the rollback command pattern 44f indicates that the operation classification is the change pattern 1. “4” of the rollback command pattern 44f indicates that the operation classification is the change pattern 2. “5” of the rollback command pattern 44f indicates that the operation classification is the change pattern 3. “6” of the rollback command pattern 44f indicates that the operation classification is the setting pattern.

A case when an attribute held by a command defining network settings is added or changed can be considered. In such a case, the rollback command pattern 44f may be stored in the rollback operation determination table 44 by associating with the added or changed attribute.

Returning to FIG. 2, the control by the rollback determination unit 36a will be described more specifically. The rollback determination unit 36a determines a distinction for each differential command about whether each of extracted differential commands is in the pre-setting command sequence or the post-setting command sequence the pre- and post-setting command difference extraction unit 35. The rollback determination unit 36a also reads attributes of differential commands for each differential command from the command template table 43. Then, the rollback determination unit 36a reads rollback command patterns corresponding to the distinction and attributes of the configuration regarding differential commands from the rollback operation determination table 44.

For example, a differential command whose “IP address” is in a post-setting command sequence on the network device side and is not in a pre-setting command sequence on the backup side will be described. The rollback determination unit 36a reads attributes of “IP address” from the command template table 43. Here, attributes of “IP address” include “0” (overwrite not permitted) for the overwrite 43d, “1” (multi-setting present) for the multi-setting 43e, and “key detail No. is 4” (single deletion influence range) for the deletion influence range 43f. Then, the rollback determination unit 36a reads the rollback command pattern corresponding to the distinction and attributes of the configuration regarding “IP address” from the rollback operation determination table 44. Here, the rollback pattern indicates “1” illustrated in P6. That is, the rollback pattern becomes the deletion pattern 1 that generates a single deletion pattern based on a differential command extracted from the network device side.

The determination result setting command generation unit 36b generates a rollback command that corresponds to the rollback pattern of the differential command acquired by the rollback determination unit 36a and defines the rollback operation. More specifically, if the rollback pattern of the differential command is “1” (deletion pattern 1), the determination result setting command generation unit 36b generates a deletion command of the differential command based on the deletion prefix 43h illustrated in the command template table 43. Then, the determination result setting command generation unit 36b sets the flag indicating whether the command is an unnecessary command to “1” (not to be an unnecessary command). The flag is set, for example, in a temporary area of the storage unit 23.

If the rollback pattern of the differential command is “2” (deletion pattern 2), the determination result setting command generation unit 36b generates a deletion command of the differential command based on the deletion prefix 43h illustrated in the command template table 43. Then, the determination result setting command generation unit 36b sets the flag to “1” (not to be an unnecessary command). Further, other commands are influenced by deletion of the differential command and thus, the determination result setting command generation unit 36b sets influenced commands as rollback commands as they are and sets the flag to “0” (to be an unnecessary command).

If the rollback pattern of the differential command is “3” (change pattern 1), the determination result setting command generation unit 36b simply makes a command on the backup side a rollback command. Then, the determination result setting command generation unit 36b sets the flag to “1” (not to be an unnecessary command).

If the rollback pattern of the differential command is “4” (change pattern 2), the determination result setting command generation unit 36b generates a differential command on the network device side based on the deletion prefix 43h illustrated in the command template table 43. Further, the determination result setting command generation unit 36b makes a command on the backup side simply a rollback command. Then, the determination result setting command generation unit 36b sets the flag to “1” (not to be an unnecessary command).

If the rollback pattern of the differential command is “5” (change pattern 3), the determination result setting command generation unit 36b generates a differential command on the network device side based on the deletion prefix 43h illustrated in the command template table 43. Then, the determination result setting command generation unit 36b sets the flag to “1” (not to be an unnecessary command). The determination result setting command generation unit 36b also generates commands influenced by deletion of the differential command from the backup side. Then, the determination result setting command generation unit 36b sets the flag to “1” (not to be an unnecessary command).

If the rollback pattern of the differential command is “6” (setting pattern), the determination result setting command generation unit 36b simply makes a command on the backup side a rollback command. Then, the determination result setting command generation unit 36b sets the flag to “1” (not to be an unnecessary command).

If the rollback pattern of the differential command is “0” (no case), the determination result setting command generation unit 36b is assumed to make the differential command simply a rollback command. Then, the determination result setting command generation unit 36b sets the flag to “1” (not to be an unnecessary command).

The unnecessary command deletion unit 36c deletes differential commands to which “0” is set by the determination result setting command generation unit 36b. That is, among differential commands, the unnecessary command deletion unit 36c deletes unnecessary commands to decide remaining differential commands as rollback setting commands.

Processing procedure for a network management apparatus according to the second embodiment

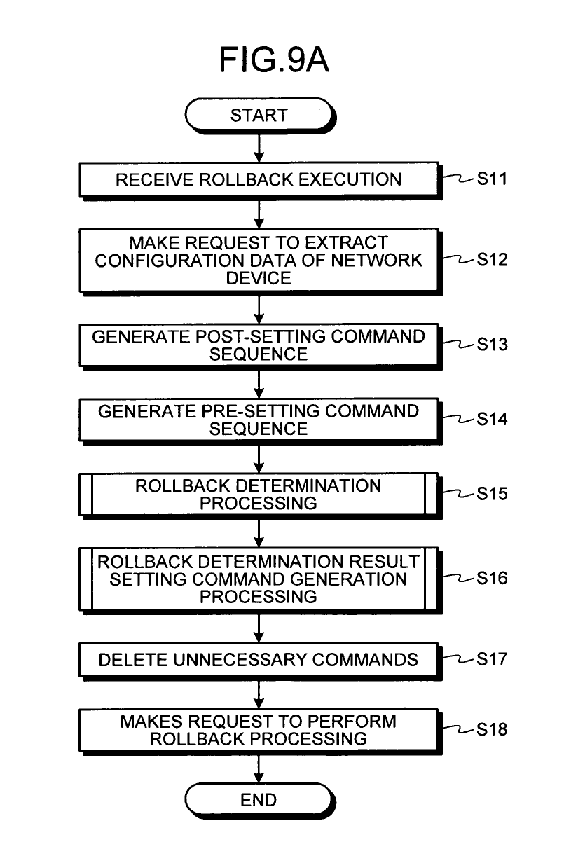

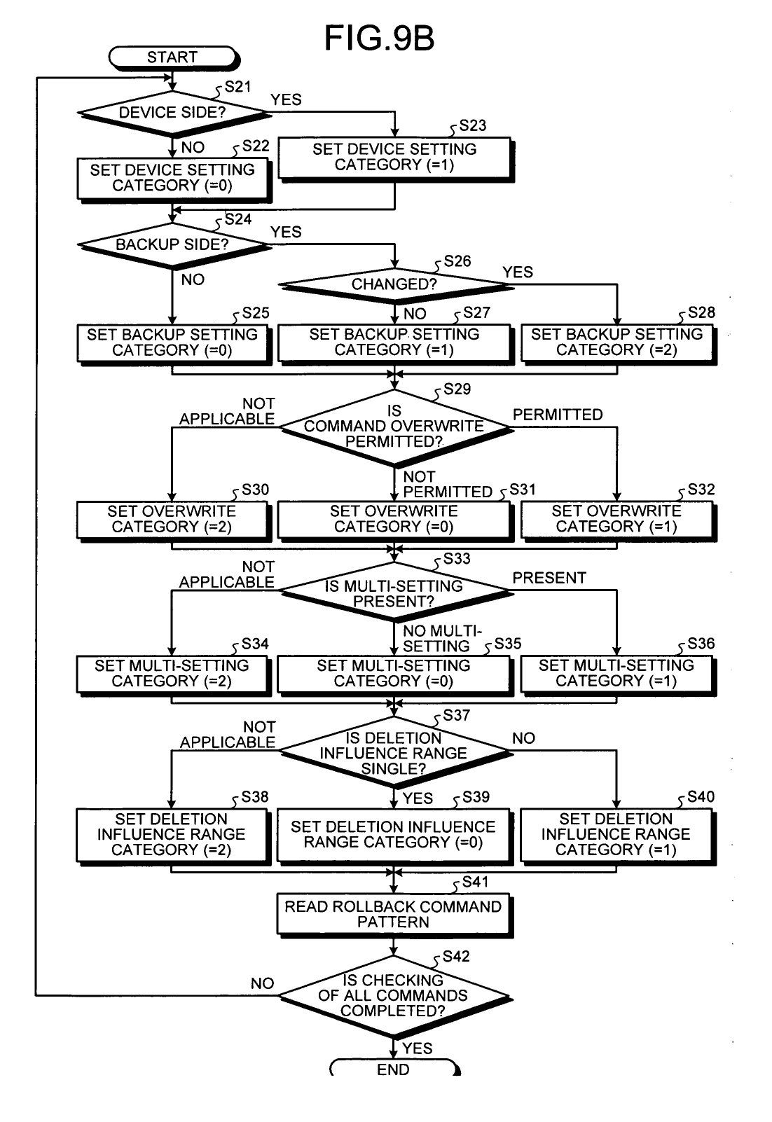

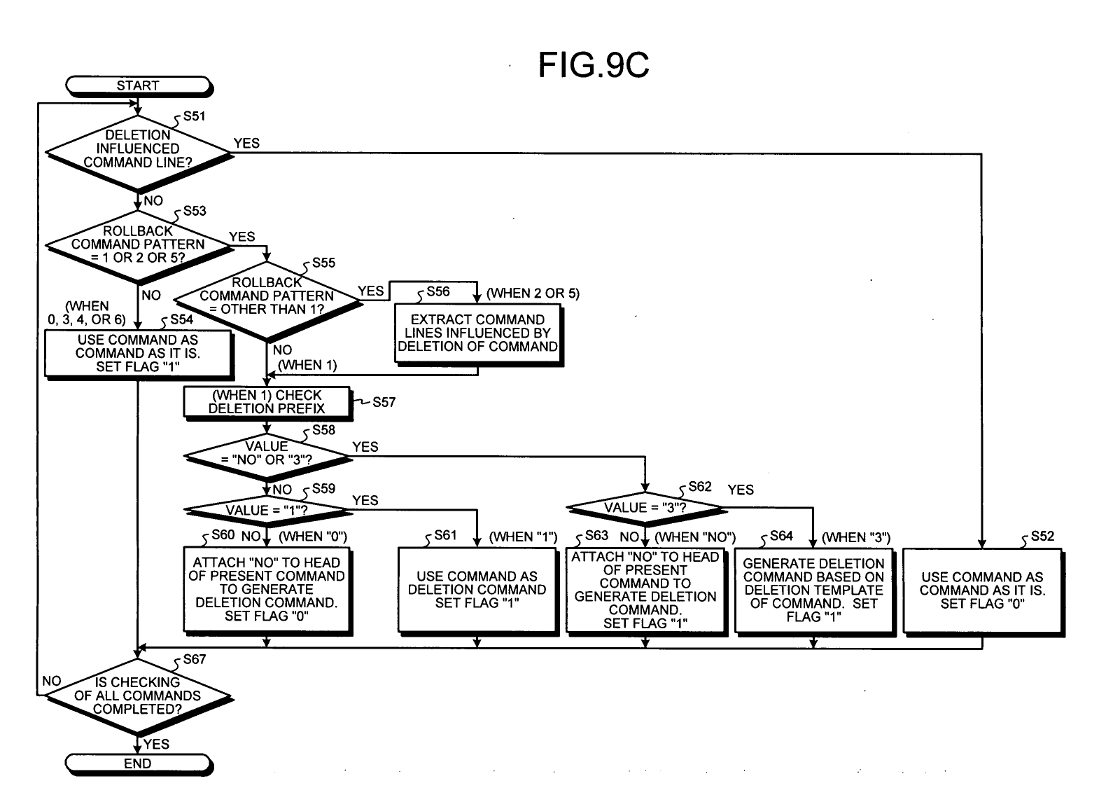

Next, the processing procedure for the network management apparatus 2 according to the second embodiment will be described with reference to FIG. 9A. FIG. 9A is a flow chart illustrating the processing procedure for the network management apparatus 2 according to the second embodiment.

First, the rollback control unit 32 receives an execution request of rollback for a network device to be rolled back from the operation unit 21 (step S11). Next, the post-setting command generation unit 33 instructs the device operation unit 22 to make a request to extract the latest configuration immediately after provisioning set to the network device to be rolled back (step S12).

Then, after acquiring an extraction result of the configuration of the relevant network device from the device operation unit 22, the post-setting command generation unit 33 generates a post-setting command sequence forming the configuration from the extraction result (step S13). Then, the pre-setting command generation unit 34 reads content of the configuration of the relevant network device from the backup management data table 42 to generate a pre-setting command sequence from the content (step S14).

Subsequently, the pre- and post-setting command difference extraction unit 35 extracts differences of command from the pre-setting command sequence and the post-setting command sequence and stores the distinction about whether each of extracted differential commands is in the pre-setting command sequence or the post-setting command sequence in the temporary area of the storage unit 23. Then, the rollback determination unit 36a acquires the rollback command pattern corresponding to attributes of each differential command extracted by the pre- and post-setting command difference extraction unit 35 from the rollback operation determination table 44 (step S15).

Subsequently, the determination result setting command generation unit 36b generates a rollback command defining the rollback operation corresponding to the rollback pattern of the differential command acquired by the rollback determination unit 36a (step S16). Then, the unnecessary command deletion unit 36c deletes, among differential commands, commands set as unnecessary commands by the determination result setting command generation unit 36b to decide remaining differential commands as rollback setting commands (step S17).

Subsequently, the unnecessary command deletion unit 36c makes a request of the device operation unit 22 to perform rollback processing using the decided rollback setting commands (step S18). Then, the rollback control unit 32 acquires a rollback processing result of the relevant network device from the device operation unit 22 and notifies the operation unit 21 of the rollback processing result.

Next, the procedure for rollback determination processing (step S15) illustrated in FIG. 9A will be described using FIG. 9B. FIG. 9B is a flow chart illustrating the procedure for rollback determination processing.

First, the rollback determination unit 36a selects one differential command from differential commands extracted from the pre-setting command sequence and post-setting command sequence. Then, the rollback determination unit 36a determines whether the selected differential command is on the network device side based on the temporary area (step S21). If the differential command is determined not to be on the network device side (step S21, No), the rollback determination unit 36a stores the network device setting category “0” in the temporary area (step S22). On the other hand, the differential command is determined to be on the network device side (step S21, Yes), the rollback determination unit 36a stores the network device setting category “1” in the temporary area (step S23).

Then, the rollback determination unit 36a determines whether the differential command is on the backup side based on the temporary area (step S24). If the differential command is determined not to be on the backup side (step S24, No), the rollback determination unit 36a stores the backup setting category “0” in the temporary area (step S25). On the other hand, if the differential command is determined to be on the backup side (step S24, Yes), the rollback determination unit 36a determines whether there is any change between the differential command on the backup side and that on the network device side (step S26). If the rollback determination unit 36a determines that there is no change between the differential command on the backup side and that on the network device side (step S26, No), the rollback determination unit 36a stores the backup setting category “1” in the temporary area (step S27). On the other hand, if the rollback determination unit 36a determines that there is a change between the differential command on the backup side and that on the network device side (step S26, Yes), the rollback determination unit 36a stores the backup setting category “2” in the temporary area (step S28).

Then, the rollback determination unit 36a determines whether the overwrite attribute of the differential command is “Permitted” based on the command template table 43 (step S29). If the overwrite attribute of the differential command is “Not permitted” (step S29, not permitted), the rollback determination unit 36a stores the overwrite category “0” in the temporary area (step S31). If the overwrite attribute of the differential command is “Permitted” (step S29, Permitted), the rollback determination unit 36a stores the overwrite category “1” in the temporary area (step S32). Further, if the overwrite attribute of the differential command is “Not applicable”, for example, if the differential command is not a command to be managed (step S29, Not applicable), the rollback determination unit 36a stores the overwrite category “2” in the temporary area (step S30).

Then, the rollback determination unit 36a determines whether the multi-setting attribute of the differential command is “Multi-setting present” based on the command template table 43 (step S33). If the multi-setting attribute of the differential command is “No multi-setting” (step S33, No multi-setting), the rollback determination unit 36a stores the multi-setting category “0” in the temporary area (step S35). If the multi-setting attribute of the differential command is “Multi-setting present” (step S33, Multi-setting present), the rollback determination unit 36a stores the multi-setting category “1” in the temporary area (step S36). Further, if the multi-setting attribute of the differential command is “Not applicable”, for example, if the differential command is not a command to be managed (step S33, Not applicable), the rollback determination unit 36a stores the multi-setting category “2” in the temporary area (step S34).

Then, the rollback determination unit 36a determines whether the deletion influence range of the differential command is single based on the command template table 43 (step S37). If the deletion influence range of the differential command is determined to be single (step S37, Yes), the rollback determination unit 36a stores the deletion influence range category “0” in the temporary area (step S39). If the deletion influence range of the differential command is determined to be a plurality (step S37, No), the rollback determination unit 36a stores the deletion influence range category “1” in the temporary area (step S40). Further, if the deletion influence range of the differential command is “Not applicable”, for example, if the differential command is not a command to be managed (step S37, Not applicable), the rollback determination unit 36a stores the deletion influence range category “2” in the temporary area (step S38).

Then, the rollback determination unit 36a reads the rollback command pattern corresponding to the network device setting category, backup setting category, overwrite category, multi-setting category, and deletion influence range category from the rollback operation determination table 44 (step S41). Then, the rollback determination unit 36a determines whether checking of all differential commands is completed (step S42). If checking of all differential commands is not completed (step S42, No), the rollback determination unit 36a selects the next differential command to proceed to step S21. On the other hand, if checking of all differential commands is completed (step S42, Yes), the rollback determination unit 36a terminates the rollback determination processing.

Next, the procedure for rollback determination result setting command generation processing (step S16) illustrated in FIG. 9A will be described using FIG. 9C. FIG. 9C is a flow chart illustrating the procedure for rollback determination result setting command generation processing.

First, the determination result setting command generation unit 36b selects one differential command from differential commands extracted from the pre-setting command sequence and post-setting command sequence. Next, the determination result setting command generation unit 36b determines whether the selected differential command is a deletion influenced command line (step S51). That is, the determination result setting command generation unit 36b determines whether the selected differential command is a command line (command line influenced by deletion of another differential command) extracted in step S56 described later.

Then, if the selected differential command is a deletion influenced command line (step S51, Yes), the determination result setting command generation unit 36b stores the command as a command as it is in the temporary area. The determination result setting command generation unit 36b will be deleted by another command and thus, the determination result setting command generation unit 36b stores the flag “0” as being an unnecessary command (step S52).

On the other hand, if the selected differential command is not a deletion influenced command line (step S51, No), the determination result setting command generation unit 36b makes the determination below. The determination result setting command generation unit 36b determines whether the rollback command pattern is “1” (deletion pattern 1), “2” (deletion pattern 2), or “5” (change pattern 3) (step S53).

If the rollback command pattern is neither “1”, nor “2”, nor “5”, that is, “0”, “3”, “4”, or “6” (step S53, No), the determination result setting command generation unit 36b stores the command as a command as it is in the temporary area. Then, the determination result setting command generation unit 36b stores the flag “1” as not being an unnecessary command (step S54). The rollback command pattern “0” indicates no case. The rollback command pattern “3” indicates the change pattern 1. The rollback command pattern “4” indicates the change pattern 2. The rollback command pattern “6” indicates the setting pattern.

On the other hand, if the rollback command pattern is “1”, “2”, or “5” (step S53, Yes), the determination result setting command generation unit 36b determines whether the rollback command pattern is other than “1” (step S55). If the rollback command pattern is other than “1”, that is, “2” or “5” (step S55, Yes), the determination result setting command generation unit 36b extracts command lines influenced if the present command is deleted based on the command template table 43 (step S56) and stores such command lines in the temporary area. The rollback command pattern “2” indicates the deletion pattern 2. The rollback command pattern “5” indicates the change pattern 3.

Further, the determination result setting command generation unit 36b checks the deletion prefix of the present command based on the command template table 43 (step S57). Here, the determination result setting command generation unit 36b determines whether the deletion prefix of the present command is “no” or “3” (deletion command other than the prefix) (step S58). If the deletion prefix of the present command is neither “no” nor “3” (step S58, No), the determination result setting command generation unit 36b determines whether the deletion prefix of the present command is “1” (unconditional command input) (step S59).

If the deletion prefix of the present command is not “1”, that is, “0” (a deletion command is not necessary) (step S59, No), the determination result setting command generation unit 36b attaches “no” to the head of the present command and generates a deletion command. Then, the determination result setting command generation unit 36b stores the flag “0” as being an unnecessary command because the deletion command is unnecessary (step S60).

On the other hand, if the deletion prefix of the present command is “1” (unconditional command input), the determination result setting command generation unit 36b generates the command directly as a deletion command. The command is input unconditionally and thus, the determination result setting command generation unit 36b stores the flag “1” as not being an unnecessary command (step S61).

If the deletion prefix of the present command is “no” or “3” (deletion command other than the prefix) (step S58, Yes), the determination result setting command generation unit 36b determines whether the deletion prefix is “3” (step S62). If the deletion prefix is not “3”, that is, “no” (step S62, No), the determination result setting command generation unit 36b attaches “no” to the head of the present command and generates a deletion command. Then, the determination result setting command generation unit 36b stores the flag “1” as not being an unnecessary command (step S63).

On the other hand, if the deletion prefix is “3” (deletion command other than the prefix) (step S62, Yes), the determination result setting command generation unit 36b generates a deletion command of the command based on the deletion template of the command template table 43. Then, the determination result setting command generation unit 36b stores the flag “1” as not being an unnecessary command (step S64).

Then, the determination result setting command generation unit 36b determines whether checking of all differential commands is completed (step S67). If checking of all differential commands is not completed (step S67, No), the determination result setting command generation unit 36b selects the next differential command to proceed to step S51. On the other hand, if checking of all differential commands is completed (step S67, Yes), the determination result setting command generation unit 36b terminates the rollback determination result setting command generation processing.

### Concrete Example 1 of Rollback Setting Command Generation

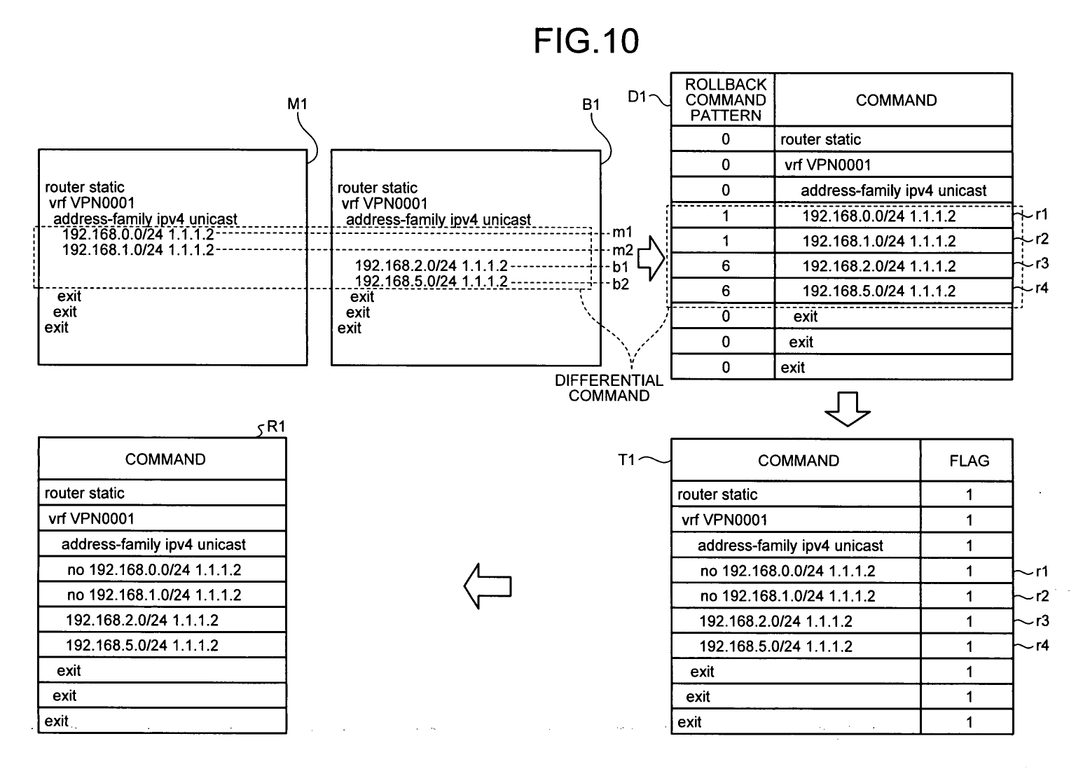

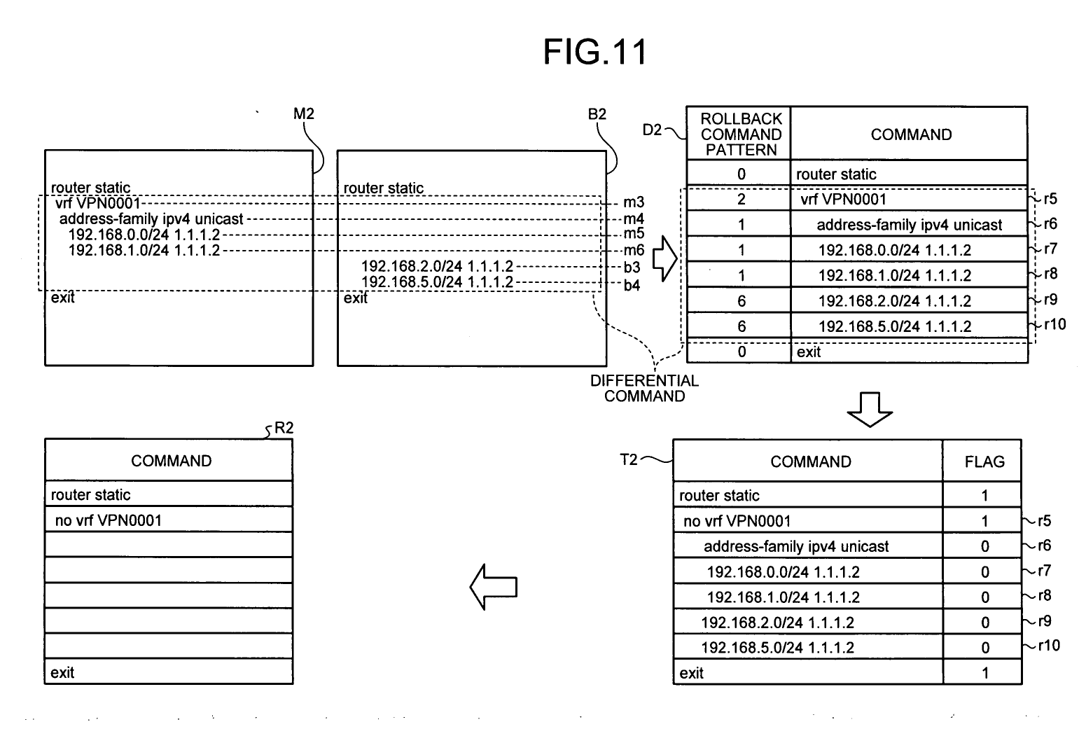

Next, a concrete example of rollback setting command generation will be described with reference to FIGS. 10 and 11. In FIG. 10, a case when the rollback command pattern of a differential command does not influence other commands will be described and in FIG. 11, a case when the rollback command pattern of a differential command influences other commands will be described. It is assumed that the post-setting command sequence, pre-setting command sequence, determination results, setting command, and rollback setting command illustrated in FIGS. 10 and 11 are information stored in the temporary area of the storage unit 23.

First, a case when the rollback command pattern of a differential command does not influence other commands will be described with reference to FIG. 10. As illustrated in FIG. 10, after acquiring the current configuration of a network device to be rolled back is acquired via the device operation unit 22, the post-setting command generation unit 33 generates a post-setting command sequence M1 forming the configuration. The pre-setting command generation unit 34 reads content of the configuration of the network device to be rolled back from the backup management data table 42 to generate a pre-setting command sequence B1 from the content. Then, the pre- and post-setting command difference extraction unit 35 extracts differences of command from the post-setting command sequence M1 and the pre-setting command sequence B1 as differential commands. Here, differential commands include commands m1, m2, b1, and b2.

Next, the rollback determination unit 36a acquires the rollback command pattern corresponding to differential command attributes from the rollback operation determination table 44 for each differential command. More specifically, after selecting the differential command m1, the rollback determination unit 36a sets the network device setting category to “1” and the backup setting category to “0” because the differential command m1 is in the post-setting command sequence M1 and not in the pre-setting command sequence B1. Then, the rollback determination unit 36a checks the differential command m1 against the template 43c of the command template table 43 to determine that the differential command m1 is an address setting command corresponding to the key detail No. 43b “4”. Then, the rollback determination unit 36a reads attributes (the overwrite 43d, the multi-setting 43e, and the deletion influence range 43f) corresponding to the key detail No. 43b “4”. Here, the overwrite attribute is “0” (not permitted) and thus the overwrite category “0” is stored, the multi-setting attribute is “1” (present) and the multi-setting category “1” is stored, and the deletion influence range attribute is “4” (single) and the deletion influence range category “4” is stored. Further, the rollback determination unit 36a reads the rollback command pattern corresponding to the network device setting category “1”, backup setting category “0”, overwrite category “0”, multi-setting category “1”, and deletion influence range category “4” from the rollback operation determination table 44. Here, the rollback determination unit 36a reads “Deletion pattern 1” as the rollback command pattern. As a result, the rollback command pattern “1” corresponding to “Deletion pattern 1” is set to r1 of a determination result D1.

Similarly, the rollback determination unit 36a successively selects the differential command and reads “Deletion pattern 1” as the rollback command pattern of the differential command m2. As a result, the rollback command pattern “1” corresponding to “Deletion pattern 1” is set to r2 of the determination result D1.

Next, after selecting the differential command b1, the rollback determination unit 36a sets the network device setting category to “0” and the backup category to “1” because the differential command b1 is not in the post-setting command sequence M1 and in the pre-setting command sequence B1. Then, the rollback determination unit 36a checks the differential command b1 against the template 43c of the command template table 43 to determine that the differential command b1 is an address setting command corresponding to the key detail No. 43b “4”. Then, the rollback determination unit 36a reads attributes (the overwrite 43d, the multi-setting 43e, and the deletion influence range 43f ) corresponding to the key detail No. 43b “4”. Here, the overwrite attribute is “0” (not permitted) and thus the overwrite category “0” is stored, the multi-setting attribute is “1” (present) and the multi-setting category “1” is stored, and the deletion influence range attribute is “4” (single) and the deletion influence range category “0” is stored. Further, the rollback determination unit 36a reads the rollback command pattern corresponding to the network device setting category “0”, backup setting category “1”, overwrite category “0”, multi-setting category “1”, and deletion influence range category “0” from the rollback operation determination table 44. Here, the rollback determination unit 36a reads “Setting pattern” as the rollback command pattern. As a result, the rollback command pattern “6” corresponding to “Setting pattern” is set to r3 of the determination result D1.

Similarly, the rollback determination unit 36a successively selects the differential command and reads “Setting pattern” as the rollback command pattern of the differential command b2. As a result, the rollback command pattern “6” corresponding to “Setting pattern” is set to r4 of the determination result D1. Commands other than differential commands exist without changing between the post-setting command sequence and in the pre-setting command sequence and thus, the rollback command pattern “0” corresponding to “No case” is set to the determination result D1.

Next, the determination result setting command generation unit 36b generates a rollback command defining the rollback operation corresponding to the rollback pattern of the differential command. More specifically, after selecting the differential command m1, the determination result setting command generation unit 36b reads the deletion prefix corresponding to the differential command m1 from the command template table 43 because the rollback command pattern of the differential command m1 is “1”. Here, the differential command m1 is an address setting command and thus, the determination result setting command generation unit 36b reads the deletion prefix 43h “no” corresponding to the key detail No. 43b “4”. Then, as illustrated by the code r1, the determination result setting command generation unit 36b sets a command obtained by attaching the read “no” to the head of the differential command m1 as a setting command T1 and sets the flag to “1” as not being an unnecessary command.

Similarly, as illustrated in the code r2, the determination result setting command generation unit 36b sets a command obtained by attaching the read “no” to the head of the differential command m2 as the setting command T1 and sets the flag to “1” as not being an unnecessary command.

Next, after selecting the differential command b1, the determination result setting command generation unit 36b decides to use the differential command b1 as it is because the rollback command pattern of the differential command b1 is “6”. Then, as illustrated in the code r3, the determination result setting command generation unit 36b sets the differential command b1 as the setting command T1 and sets the flag to “1” as not being an unnecessary command. Similarly, as illustrated in the code r4, the determination result setting command generation unit 36b sets the differential command b2 as the setting command T1 and sets the flag to “1” as not being an unnecessary command. Commands other than differential commands exist as they are in the post-setting command sequence without changing from the pre-setting command sequence and thus, the flag is set to “1” as not being unnecessary commands.

Then, the unnecessary command deletion unit 36c deletes, among commands set as the setting commands T1, commands set as being unnecessary commands to generate rollback setting commands. That is, the unnecessary command deletion unit 36c deletes commands whose flag is “0” among commands set as the setting commands T1 to set remaining commands as rollback setting commands. As a result, among commands set as the setting commands T1, the commands illustrated in the codes r1 to r4 and commands that do not change are generated as the rollback setting commands R1.

Accordingly, if rollback processing using rollback setting commands is performed on a network device, the backed-up configuration of the network device immediately before provisioning will be restored.

### Concrete Example 2 of Rollback Setting Command Generation

Next, a case when the rollback command pattern of a differential command influences other commands will be described with reference to FIG. 11. As illustrated in FIG. 11, after acquiring the current configuration of a network device to be rolled back is acquired via the device operation unit 22, the post-setting command generation unit 33 generates a post-setting command sequence M2 forming the configuration. The pre-setting command generation unit 34 reads content of the configuration of the network device to be rolled back from the backup management data table 42 to generate a pre-setting command sequence B2 from the content. Then, the pre- and post-setting command difference extraction unit 35 extracts differences of command from the post-setting command sequence M2 and the pre-setting command sequence B2 as differential commands. Here, differential commands include commands m3 to m6, b3, and b4.

Next, the rollback determination unit 36a acquires the rollback command pattern corresponding to differential command attributes from the rollback operation determination table 44 for each differential command. More specifically, after selecting the differential command m3, the rollback determination unit 36a sets the network device setting category to “1” and the backup category to “0” because the differential command m3 is in the post-setting command sequence M2 and not in the pre-setting command sequence B2. Then, the rollback determination unit 36a checks the differential command m3 against the template 43c of the command template table 43 to determine that the differential command m3 is a vrf command corresponding to the key detail No. 43b “2”. Then, the rollback determination unit 36a reads attributes (the overwrite 43d, the multi-setting 43e, and the deletion influence range 43f) corresponding to the key detail No. 43b “2”. Here, the overwrite attribute is “0” (not permitted) and thus the overwrite category “0” is stored, the multi-setting attribute is “0” (none) and the multi-setting category “0” is stored, and the deletion influence range attribute is “5” (a plurality) and the deletion influence range category “1” is stored. Further, the rollback determination unit 36a reads the rollback command pattern corresponding to the network device setting category “1”, backup setting category “0”, overwrite category “0”, multi-setting category “0”, and deletion influence range category “1” from the rollback operation determination table 44. Here, the rollback determination unit 36a reads “Deletion pattern 2” as the rollback command pattern. As a result, the rollback command pattern “2” corresponding to “Deletion pattern 2” is set to r5 of a determination result D2.

Similarly, the rollback determination unit 36a successively selects the differential command and reads the rollback command pattern of the differential command from the rollback operation determination table 44. As a result, the rollback command pattern “1” corresponding to “Deletion pattern 1” for each of the differential commands m4 to m6 is set to r6 to r8 of the determination result D2 respectively. Also, the rollback command pattern “6” corresponding to “Setting pattern” for each of the differential commands b3 and b4 is set to r9 and r10 of the determination result D2 respectively.

Next, the determination result setting command generation unit 36b generates a rollback command defining the rollback operation corresponding to the rollback pattern of the differential command. More specifically, after selecting the differential command m3, the determination result setting command generation unit 36b extracts command lines influenced by deletion of the differential command m3 based on the command template table 43 because the rollback command pattern of the differential command m3 is “2” and stores such command lines in the temporary area. Here, the deletion influence range attribute is “5” (a plurality) and command lines influenced by deletion of the differential command m3 are commands whose key detail No. 43b is “3” (key details of the differential command m3) to “5”. That is, the IPv4 declaration command whose key detail No. 43b indicates “3”, the address setting command whose key detail No. 43b indicates “4”, and the exit command whose key detail No. 43b indicates “5”.

Next, the determination result setting command generation unit 36b reads the deletion prefix corresponding to the differential command m3 from the command template table 43. Here, the differential command m3 is a vrf command and thus, the determination result setting command generation unit 36b reads the deletion prefix 43h “no” corresponding to the key detail No. 43b “2”. Then, the determination result setting command generation unit 36b sets, as illustrated in the code r5, a command obtained by attaching the read “no” to the head of the differential command m3 as a setting command T2 and sets the flag to “1” as not being an unnecessary command.

Next, the determination result setting command generation unit 36b reads differential commands of command lines influenced by deletion of the differential command m3 from the temporary area, sets these differential commands as commands as they are, and sets the flag to “0” as being unnecessary commands. That is, the determination result setting command generation unit 36b sets, as illustrated in the codes r6 to r10, the differential commands as the setting commands T2 and sets the flag to “0” as being unnecessary commands. Commands other than differential commands exist as they are in the post-setting command sequence without changing from the pre-setting command sequence and thus, the flag is set to “1” as not being unnecessary commands. Therefore, even if the exit command is a command line influenced by deletion of the differential command m3, the flag is set to “1” as not being an unnecessary command because the differential command m3 is a command other than a differential command.

Then, the unnecessary command deletion unit 36c deletes, among commands set as the setting commands T2, commands set as being unnecessary commands to generate rollback setting commands. That is, the unnecessary command deletion unit 36c deletes commands whose flag is “0” among commands set as the setting commands T2 to set remaining commands as rollback setting commands. As a result, among commands set as the setting commands T2, the command illustrated in the code r5 and commands that do not change are generated as the rollback setting commands R2.

Accordingly, if rollback processing using rollback setting commands is thereafter performed on a network device, the backed-up configuration of the network device immediately before provisioning will be restored. That is, in the example in FIG. 11, while setting addresses are actually set in the backup immediately before provisioning, no vrf command is set. Therefore, preventing setting addresses, which may not originally be set, but are set, from being set, restores the proper configuration.

### Effects of the Second Embodiment

According to the above second embodiment, the network management apparatus 2 includes the command template table 43 that stores attributes held by each command for each command that can be set to the configuration. The rollback determination unit 36a acquires attributes of commands of differences between a pre-setting command sequence and a post-setting command sequence extracted by the pre- and post-setting command difference extraction unit 35. Then, the rollback determination unit 36a acquires the rollback command pattern corresponding to acquired attributes and the distinction before or after configuration settings from which the command is formed from the rollback operation determination table 44 for each command. Then, the determination result setting command generation unit 36b generates a rollback command based on the rollback command pattern for each command acquired by the rollback determination unit 36a.

Accordingly, the network management apparatus 2 generates a rollback command corresponding to the rollback command pattern associated with attributes held by a differential command. Thus, in contrast to a case when a rollback command that simply cancels a differential command, the network management apparatus 2 can generate a proper rollback command. As a result, in contrast to a case when a generated rollback command that simply cancels a command when set to a network device is set, the network management apparatus 2 can avoid being restored to an improper configuration.

According to the second embodiment, when an attribute of a command that can be set to the configuration is added or changed, the attribute of the command can be added to the command template table 43 or changed. Accordingly, each time an attribute of a command is added, the command template table 43 can be changed in accordance with the addition. Thus, even if the type of network device is added or firmware is upgraded, the network management apparatus 2 can realize rollback command generation processing capable of flexibly dealing with such changes.

According to the second embodiment, when an attribute held by a command defining network settings is added or changed, the rollback operation determination table 44 stores the rollback command pattern by associating with the added or changed attribute. Accordingly, each time an attribute of a command is added, the rollback operation determination table 44 can be changed in accordance with the addition. Thus, even if the type of network device is added or firmware is upgraded, the rollback operation determination table 44 can realize rollback command generation processing capable of flexibly dealing with such changes.

According to the second embodiment, attributes held by a command defining network settings are assumed to contain at least one of overwrite permission/non-permission, presence/absence of multi-settings, and an influence range when a command is deleted. Accordingly, if, for example, attributes include the overwrite permission/non-permission, the network management apparatus 2 can avoid causing a setting failure by simply making an overwrite setting for a command that cancels a command that may not be overwritten.

Programs and the Like

The post-setting command generation unit 33 in the second embodiment has been described by assuming that a post-setting command sequence forming a configuration is generated from the current configuration of a network device acquired via the device operation unit 22. However, the second embodiment is not limited to this and the post-setting command generation unit 33 may generate a post-setting command sequence based on the management data table 41 in which content of the latest configuration set to a network device is stored.

The above second embodiment has been described by assuming that attributes include the “Overwrite attribute”, “Multi-setting attribute”, and “Deletion influence range attribute”. However, attributes are not limited to the above attributes and any attribute held by a command and to be a constraint when a rollback command is generated may also be adopted.

In the above second embodiment, the rollback determination unit 36a reads differential command attributes from the command template table 43 and acquires the rollback command pattern corresponding to the read attributes from the rollback operation determination table 44. However, a differential command present in a post-setting command sequence may be a command not to be managed by the network management apparatus 2 and thus is not stored in the command template table 43. Even in such a case, the rollback determination unit 36a may be allowed to acquire a rollback command pattern so that a rollback command is directly generated from the rollback operation determination table 44. In such a case, data having the network device setting category 44a “Set”, the backup setting category 44b “No setting”, all attributes “Not applicable”, and the rollback command pattern 44f “6” (setting pattern) is added to the rollback operation determination table 44. Then, the rollback determination unit 36a can acquire a rollback command pattern corresponding to a command not to be managed so that the determination result setting command generation unit 36b can be caused to generate a rollback command corresponding to the rollback command pattern. Accordingly, the network management apparatus 2 can prevent a command set to a network device from outside the network management apparatus 2 from being unconditionally deleted during rollback.

Each illustrated component of the network management apparatus 2 need not necessarily be physically configured as illustrated. That is, a concrete form of division/integration of the network management apparatus 2 is not limited to the illustrated one and all or a portion thereof may be functionally or physically divided/integrated for configuration in any unit in accordance with various loads or usage. For example, the pre- and post-setting command difference extraction unit 35 and the rollback command generation unit 36 may be integrated into one unit. On the other hand, the rollback determination unit 36a may be divided into an attribute acquisition unit that acquires command attributes and a rollback command pattern acquisition unit that acquires a rollback command pattern corresponding to attributes. The storage unit 23, the operation unit 21, or the device operation unit 22 may be made an external apparatus of the network management apparatus 2 that is connected via a network.

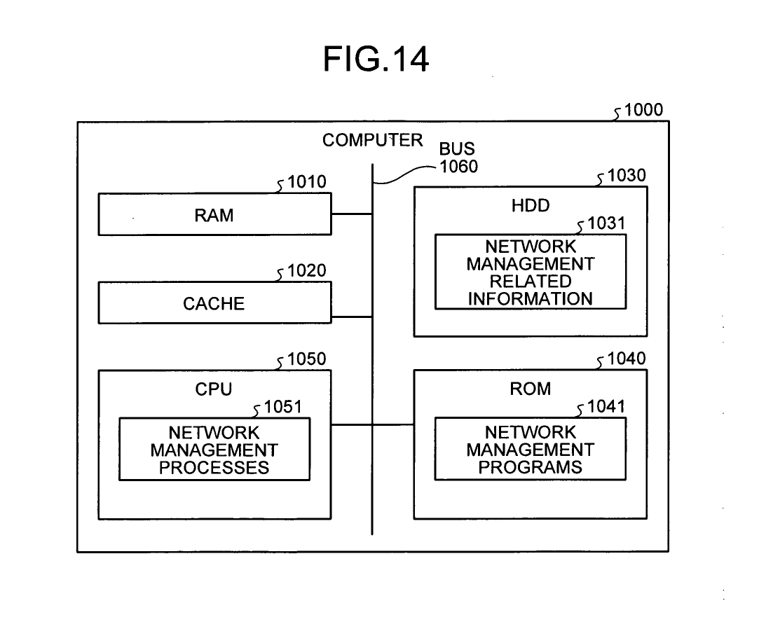

Various kinds of processing described in the above embodiments can also be realized by executing prepared programs on a computer such as a personal computer and workstation. Thus, an example of a computer executing network management programs having functions similar to those of the network management apparatus 2 illustrated in FIG. 2 will be described using FIG. 14.

FIG. 14 is a diagram illustrating a computer executing a network management program. As illustrated in FIG. 14, a computer 1000 includes a Random Access Memory (RAM) 1010, a cache 1020, an HDD 1030, a Read Only Memory (ROM) 1040, a CPU (Central Processing Unit) 1050, and a bus 1060. The RAM 1010, the cache 1020, the HDD 1030, the ROM 1040, and the CPU 1050 are connected to the bus 1060.

The ROM 1040 has network management programs 1041 that fulfill the functions similar to those of the network management apparatus 2 illustrated in FIG. 2 stored therein.

The CPU 1050 reads and executes these network management programs 1041. Accordingly, as illustrated in FIG. 14, the network management programs 1041 become network management processes 1051. The network management processes 1051 correspond to the provisioning execution unit 31, the rollback control unit 32, the post-setting command generation unit 33, the pre-setting command generation unit 34, the pre- and post-setting command difference extraction unit 35, and the rollback command generation unit 36.

The HDD 1030 is provided with, as illustrated in FIG. 14, network management related information 1031. The network management related information 1031 corresponds to, for example, the management data table 41, the backup management data table 42, the command template table 43, and the rollback operation determination table 44 as illustrated in FIG. 2.

The network management programs 1041 need not necessarily be caused to store in the ROM 1040. For example, a flexible disk (FD) inserted into the computer 1000, CD-ROM, MO disk, DVD disk, magneto-optical disk, or “portable physical medium” such as an IC card may be caused to store the network management programs 1041. Or, a “fixed physical medium” such as a hard disk drive (HDD) provided inside/outside the computer 1000 may be caused to store the network management programs 1041. Or, “another computer (or server)” connected to the computer 1000 via a public network, the Internet, LAN, or WAN may be caused to store the network management programs 1041. Then, the computer 1000 may execute the programs by reading the programs from a flexible disk or the like.

According to an embodiment of the network management apparatus disclosed by the present application, an effect of being able to properly roll back setting information for network devices connected to a network to the previous setting information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it may be understood that the various changes, substitutions, and alterations could be made hereto without departing from the spirit and scope of the invention.

What is claimed is:

1. A network management apparatus, comprising:
a processor; and
a storage that stores an operation type indicating a rollback operation method by associating with attributes held by a command defining network settings, wherein the processor executes:
extracting a difference between a command forming current setting information and a command forming previous setting information when the setting information set by the command is brought back to the previous setting information; and
acquiring the operation type corresponding to extracted command attributes from the storage unit, to generate a rollback command defining the rollback operation in accordance with the acquired operation type.

2. The network management apparatus according to claim 1, wherein the storage stores attributes held by each command for each command that can be set to the setting information, and
the processor executes:
acquiring attributes of the command regarding the command whose difference is extracted from the storage,
acquiring the operation type corresponding to the acquired attributes and a distinction of the setting information from which the command is formed from the storage for each command, and
generating the rollback command based on the operation type for each command.

3. The network management apparatus according to claim 2, wherein
the storage adds or changes the attribute for the command when the attribute of the command that can be set to the setting information is added or changed.

4. The network management apparatus according to claim 1, wherein
the storage stores the operation type by associating with the added or changed attribute when the attribute held by the command defining network settings is added or changed.

5. The network management apparatus according to claim 1, wherein the attributes include a command overwrite permission/non-permission, a presence/absence of multi-settings, or an influence range when the command is deleted or any combination thereof.

6. A network management method, comprising:
extracting a difference between a command forming current setting information and a command forming previous setting information when the setting information set by the command is brought back to the previous setting information; and
acquiring the operation type corresponding to extracted command attributes from a storage unit that stores an operation type indicating a rollback operation method by associating with attributes held by a command defining network settings, to generate a rollback command defining the rollback operation in accordance with the acquired operation type.

7. A non-transitory computer readable storage medium having stored therein a network management program causing a computer to execute a process comprising:
extracting a difference between a command forming current setting information and a command forming previous setting information when the setting information set by the command is brought back to the previous setting information; and
acquiring the operation type corresponding to extracted command attributes from a storage unit that stores an operation type indicating a rollback operation method by associating with attributes held by a command defining network settings, to generate a rollback command defining the rollback operation in accordance with the acquired operation type.
